(19) United States
(12) Patent Application Publication
(10) Pub. No.: US 2004/0131901 A1
(43) Pub. Date: Jul. 8, 2004

(54) Hydrogen supply unit

(76) Inventors: Ikuya Yamashita, Wako-shi (JP); Norio Komura, Wako-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/650,044

(22) Filed: Aug. 28, 2003

(30) Foreign Application Priority Data
Aug. 30, 2002 (JP) 2002-255467

(51) Int. Cl. H01M 8/04; C01B 6/24

(52) U.S. Cl. 429/17; 423/644

(57) ABSTRACT

A hydrogen supply unit is provided that can efficiently supply hydrogen gas both to a fuel cell used as a stationary electric power supply and to a fuel cell used as a mobile electric power supply. The hydrogen supply unit includes a reformer 5 that reforms a source gas to generate hydrogen gas, a first storage device 7 that stores hydrogen gas and supplies the hydrogen gas to a first fuel cell 2, and a second storage device 8 that stores hydrogen gas and supplies the hydrogen gas to a second fuel cell 3. For the storage device 8, there is arranged a compressor 13 that pressurizes hydrogen gas. For both storage devices 7 and 8, there is arranged a purifier 6 between the reformer 5 and both storage devices so that both storage devices store purified hydrogen gas. The storage device 7 utilizes a hydrogen absorbing alloy, and releases hydrogen gas by taking advantage of the waste heat of the reformer 5 or the waste heat of the fuel cell 2. The hydrogen gas stored in the storage device 8 is pressurized to 10 to 70 MPa. The hydrogen supply unit includes a remaining amount detecting sensor 14 for hydrogen gas that detects the remaining amount of the hydrogen gas in the storage device 8, and a control device 15 that feedback controls the reformer 5 on the basis of the above described remaining amount of the hydrogen gas.

### BACKGROUND OF THE INVENTION

1. Field of the Invention

The present invention relates to a hydrogen supply unit that supplies hydrogen gas, obtained by reforming a source gas such as natural gas, both to a fuel cell supplying electric power to ordinary household electric appliances arranged in the interior of a house and to a fuel cell installed in an automobile including an electric vehicle.

2. Description of the Related Art

In these years, it has been considered that electric power is generated by use of fuel cells in ordinary household to supply electric power to electric appliances used in the household. In this context, a problem that how hydrogen gas is supplied as fuel for the above described fuel cells is raised.

In order to overcome the above described problem, an approach has been considered in which hydrogen gas is obtained by reforming the commercial gas such as city gas supplied to ordinary household. For example, hydrogen gas can be produced by reforming natural gas used as city gas through making the natural gas to react with water.

There have hitherto been known hydrogen supply units which supply hydrogen gas, obtained by reforming at ordinary household source gas such as natural gas, to fuel cells as stationary electric power supplies for supplying electric power to household electric appliances (for example, see Japanese Patent Laid-Open No. 6-333584).

The above described hydrogen supply unit comprises a reformer that reforms a source gas such as natural gas supplied to ordinary household into a reformed gas containing hydrogen as a main component, and a purifier that purifies the reformed gas obtained by means of the reformer to yield hydrogen gas, and thus the hydrogen gas obtained by means of the purifier is supplied to the above described fuel cell. In this case, the above described reformer is provided with capability to generate such an amount of hydrogen gas as required for supplying the electric power when all the above described electric appliances arranged in the interior of a house are used.

However, the capability of the above described reformer is not fully utilized when only some of the above described electric appliances are used. Accordingly, in the above described hydrogen supply unit, the above described reformer is always operated to a full extent, while the surplus hydrogen gas is stored in a tank under high pressure, or stored by use of a hydrogen absorbing alloy. The stored hydrogen gas as described above is used, for example, for supplying hydrogen gas to the fuel cells at the time of activating the reformer until a sufficient amount of hydrogen gas comes to be obtained from the reformer.

On the other hand, it has been proposed that the hydrogen gas, obtained by reforming a source gas such as natural gas supplied to ordinary household, is supplied to a fuel cell as a mobile electric power supply installed in an automobile such as an electric vehicle, and hydrogen supply units to meet such purposes are known (for example, see Japanese Patent Laid-Open No. 10-139401).

The above described hydrogen supply unit to supply hydrogen gas to a fuel cell installed in an electric vehicle comprises a reformer that reforms a source gas such as natural gas supplied to ordinary household to generate a reformed gas containing hydrogen gas as a main component, a purifier that purifies the reformed gas obtained by means of the reformer to yield hydrogen gas, a compressor that compresses the hydrogen gas obtained by means of the purifier, and a tank to store the compressed hydrogen gas under high pressure. Additionally, the above described hydrogen supply unit may be a unit that comprises the above described reformer and purifier, and stores the hydrogen gas obtained by means of the purifier by use of a hydrogen absorbing alloy.

By means of the above described hydrogen supply unit, hydrogen gas can be supplied to the fuel cell installed in the above described electric vehicle. Additionally, when hydrogen gas is stored under high pressure in the above described tank, the hydrogen gas can be supplied in a short time to the tank installed in the above described electric vehicle or the like.

Now, when the hydrogen gas obtained as described above is to be supplied both to a fuel cell as the above described stationary electric power supply and to a fuel cell as the above described mobile electric power supply, it is convenient to store the hydrogen gas in the above described tank under high pressure for the purpose of supplying in a short time the hydrogen gas to the tank equipped in the fuel cell as a mobile electric power supply.

However, it is not necessarily needed to store, under high pressure, the hydrogen gas to be supplied to a fuel cell as a stationary electric power supply for supplying power to household electric appliances, and high pressure storage of hydrogen gas is sometimes disadvantageous in terms of energy.

Additionally, when the above described hydrogen gas is stored with the aid of a hydrogen absorbing alloy, the hydrogen gas can be stored without elevating the pressure thereof, which is convenient for supplying to a fuel cell as the above described stationary electric power supply, but causes such inconvenience that a long time is needed for supplying to the tank equipped in the above described fuel cell as mobile electric power supply.

### SUMMARY OF THE INVENTION

The present invention takes as its object the provision of a hydrogen supply unit, through overcoming such inconvenience as described above, which can efficiently supply hydrogen gas, obtained by reforming a source gas supplied to ordinary household, both to a fuel cell used as a stationary electric power supply for supplying electric power to household electric appliances and to a fuel cell installed in an electric vehicle or the like and used as a mobile electric power supply.

For the purpose of achieving such an object as described above, the hydrogen supply unit of the present invention comprising a reforming means for generating hydrogen gas by reforming a source gas, a first storage means for storing and supplying the hydrogen gas obtained by the reforming means to a first fuel cell used as a stationary electric power supply, and a second storage means for storing the hydrogen gas obtained by the reforming means and supplies to a second fuel cell used as a mobile electric power supply, wherein the second storage means comprises a pressurization means for pressurizing the hydrogen gas to be stored.

According to the hydrogen supply unit of the present invention, at the beginning, hydrogen gas is generated by reforming a source gas such as natural gas by the above described reforming means. Then, the hydrogen gas obtained by means of the reforming means is stored in the first storage means and the second storage means.

In this context, in the above described reforming means, the reactions represented by the following formulas (1) and (2) occur as exemplified below with methane:

CH₄+H₂O→CO+3H₂ (1)

CO+H₂O→CO₂+H₂ (2)

Combining the formulas (1) and (2) gives the following formula (3), which shows that hydrogen gas is obtained from methane gas and water, and the hydrogen gas contains carbon dioxide gas:

CH₄+2H₂O→CO₂+4H₂ (3)

Thus, it is preferable that in the hydrogen supply unit of the present invention, for both storage means, there is arranged a purifying means for purifying hydrogen gas, between the above described reforming means and both storage means, and both storage means store the hydrogen gas having been purified by the purifying means.

The above described first storage means supplies hydrogen gas to the above described first fuel cell used as a stationary electric power supply for supplying electric power to household electric appliances and the like, and it is not necessarily needed that the hydrogen gas supplied to the above described first fuel cell has a high pressure. Thus, as the above described first storage means, a means for storing the hydrogen gas with the aid of a hydrogen absorbing alloy can be used. The above described hydrogen absorbing alloy absorbs selectively hydrogen gas so that the hydrogen gas released from the above described hydrogen absorbing alloy to be supplied to the above described first fuel cell can be made much higher in purity than the hydrogen gas purified by the above described purifying means.

It is necessary to heat the absorbing alloy, for the purpose of releasing the absorbed hydrogen gas from the above described hydrogen absorbing alloy. Accordingly, in the hydrogen supply unit of the present invention, the waste heat of the above described reforming means or the waste heat of the above described first fuel cell is utilized for the purpose of releasing the hydrogen gas from the above described hydrogen absorbing alloy, and thus the above described waste heat can be effectively taken advantage of.

Additionally, the above described second storage means supplies hydrogen gas to the second fuel cell used as a mobile electric power supply installed in an automobile such as an electric vehicle. The above described second fuel cell comprises a storage means of its own other than the above described second storage means, and the second fuel cell is supplied with hydrogen gas from the storage means of its own while moving. Thus, the above described second storage means stores the hydrogen gas pressurized by the above described pressurizing means for the purpose of supplying the stored hydrogen gas in a short time to the storage means of the above described second fuel cell's own.

In this case, the storage means of the above described second fuel cell's own is limited in volume for the sake of mobility, and it is preferable that the hydrogen gas stored in such a storage means of the above described second fuel cell's own is much higher in purity than the hydrogen gas purified by the above described purifying means. Accordingly, it is preferable that, for the above described second storage means, a purifying means of its own is arranged between the above described pressurizing means and the above described purifying means.

It is preferable that the hydrogen gas stored in the above described second storage means is pressurized by the above described pressurizing means to the pressure range from 10 to 70 MPa for the purpose of supplying thereof in a short time to the tank of the above described automobile or the like. As for the pressure of the above described hydrogen gas, when the pressure is lower than 10 MPa, it is difficult to supply hydrogen gas in a short time to the tank of the above described automobile or the like, while when the pressure exceeds 70 MPa, there occurs a problem that the strength of the material forming the tank needs to be increased, or hydrogen tends to penetrate through the tank wall.

In the hydrogen supply unit of the present invention, independent storage meanss are arranged respectively for the first fuel cell used as a stationary electric power supply and for the second fuel cell used as mobile electric power supply; hydrogen gas is stored, without being pressurized but by use of a hydrogen absorbing alloy and the like, in the first storage means for supplying hydrogen gas to the first fuel cell; and for the second storage means for supplying hydrogen gas to the second fuel cell, there is arranged a pressurizing means so that the second storage means stores pressurized hydrogen gas. Accordingly, the hydrogen supply unit of the present invention does not perform needless pressurization of the hydrogen gas to be stored, and hence can suppress the energy consumption and, on the other hand, can supply hydrogen in a short time to the second fuel cell used as a mobile electric power supply.

Additionally, the hydrogen supply unit of the present invention is characterized in that the unit comprises a remaining amount detecting means for hydrogen gas for detecting the remaining amount of the hydrogen gas stored in the above described second storage means, and a control means for feedback controlling the amount of the hydrogen gas generated in the above described reforming means on the basis of the remaining amount of the hydrogen gas detected by means of the remaining amount detecting means for hydrogen gas.

According to the hydrogen supply unit having such a configuration, if small is the remaining amount of the hydrogen gas stored in the above described second storage means detected by the above described remaining amount detecting means for hydrogen gas, the amount of the hydrogen gas generated by the above described reforming means is increased with the aid of the above described control means. On the other hand, if large is the remaining amount of the hydrogen gas stored in the above described second storage means detected by the above described remaining amount detecting means for hydrogen gas, the amount of the hydrogen gas generated by the above described reforming means is decreased with the aid of the above described control means. Consequently, the generation of surplus amount of hydrogen gas is prevented so that the above described reforming means can be operated properly.

### BRIEF DESCRIPTION OF THE DRAWING

FIG. 1 is a block diagram showing the configuration of a hydrogen supply unit of an embodiment of the present invention.

### DETAILED DESCRIPTION OF THE PREFERRED EMBODIMENT

Now, further detailed description will be made below on an embodiment of the present invention with reference to the accompanying drawing.

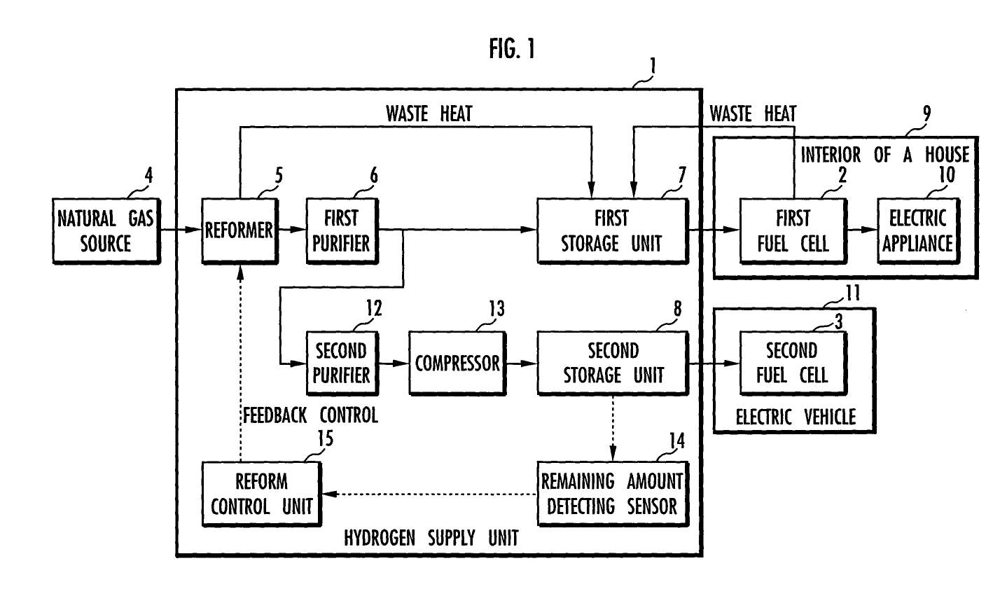

As FIG. 1 shows, a hydrogen supply unit 1 of the present invention is used for supplying hydrogen gas to fuel cells 2 and 3 in ordinary household, and comprises a reformer 5 that reforms the natural gas supplied from a natural gas source 4, a first purifier 6 that purifies the hydrogen gas obtained by means of the reformer 5, and a first storage unit 7 and a second storage unit 8 that store the hydrogen gas.

The first storage unit 7 supplies hydrogen to the first fuel cell 2 and is made to store hydrogen gas by means of a hydrogen absorbing alloy. The first fuel cell 2 is arranged in an interior 9 of a house and is a stationary electric power supply that supplies electric power to an electric appliance 10.

As the above described hydrogen absorbing alloy, there can be used, for example, rare earth element based alloys including MmNi_{4.8}Al_{0.2} (here, Mm signifies a misch metal), titanium based alloys including TiCr_{1.6}Fe_{0.2} and the like.

The second storage unit 8 supplies hydrogen to the second fuel cell 3 installed in an electric vehicle 11 and is made so as to store the hydrogen gas that has been made further higher in purity by means of a second purifier 12 arranged between the first purifier 6 and a compressor 13, under a pressure range from 10 to 70 MPa attained by pressurizing with the compressor 13. As the first purifier 6, a hydrogen separator comprising a hydrogen separation membrane containing palladium or palladium alloy and other separators can be used. Additionally, as the second purifier 12, a hydrogen separator that utilizes the press swing absorption (PSA) method and other separators can be used, and can purify the hydrogen gas purified by means of the first purifier 6 to a further higher degree of purity.

Additionally, for the second storage unit 8 there is arranged a remaining amount detecting sensor 14 that detects the remaining amount of the stored hydrogen gas, and the remaining amount detecting sensor 14 is connected to a reform control unit 15 that controls the operation of the reformer 5. The reform control unit 15 is configured with a computer composed of, for example, CPU, ROM, RAM and the like.

In the next place, description is made below on the hydrogen supply unit 1 of the present embodiment.

In the hydrogen supply unit 1, hydrogen gas is obtained by using as a source gas natural gas supplied to ordinary household as commercial gas such as city gas. Thus, in the first place, natural gas is supplied to the reformer 5 from a natural gas source 4 such as a gas valve.

The reformer 5 generates hydrogen gas by making the above described natural gas and water supplied from a water supply source not shown in the figure react with each other according to the following formulas (1) and (2):

CH₄+H₂O→CO+3H₂ (1)

CO+H₂O→CO₂+H₂ (2)

Combining the formulas (1) and (2) gives the following formula (3) which shows that the hydrogen gas generated by the reformer 5 contains carbon dioxide gas:

CH₄+2H₂O→CO₂+4H₂ (3)

The reaction represented by formula (3) is an endothermic reaction, and accordingly the reformer 5 generates, by being heated, the above described hydrogen gas from the above described natural gas. The waste heat released from the reformer 5 is used in the first storage unit 7 as will be described later.

In the next place, the hydrogen gas generated by means of the reformer 5 is purified in the first purifier 6 into pure hydrogen, part of which is stored in the first storage unit 7 in which a hydrogen absorbing alloy is used. In this case, the hydrogen absorbing alloy selectively absorbs only hydrogen gas so that a hydrogen gas much higher in purity than the pure hydrogen purified by means of the first purifier 6 can be obtained from the first storage unit 7.

The hydrogen gas stored in the hydrogen absorbing alloy in the first storage unit 7 is released by heating the hydrogen absorbing alloy and supplied to the first fuel cell 2 arranged in the interior 9 of a house. The heating of the above described hydrogen absorbing alloy can be conducted by using, at least as part of heat source, the waste heat of the reformer 5 or the waste heat of the first fuel cell 2 itself. The first fuel cell 2 may be equipped with a heating device for heating the above described hydrogen absorbing alloy, and use of the heating device can be avoided when heating of the above described hydrogen absorbing alloy can be made only with the waste heat of the above described reformer 5 or the waste heat of the first fuel cell 2 itself.

The remainder of the pure hydrogen obtained by purification in the first purifier 6 is purified in the second purifier 12 to a higher purity hydrogen, and pressurized by the compressor 13 and stored in the second storage unit 8. The second storage unit 8 is a tank in which the above described hydrogen gas is stored as gas, and accordingly it is desirable that the hydrogen to be stored is as high in purity as possible for the purpose of permitting effective use of the limited volume of the tank. In the present embodiment, a high purity hydrogen gas can be stored in the second storage unit 8 by further subjecting the pure hydrogen obtained by purification in the first purifier 6 to the purification in the second purifier 12 based on the PSA method.

A tank (not shown in the figure) installed in an electric vehicle 11 can be filled with the hydrogen gas stored in the second storage unit 8, by connecting the second storage unit 8 and the tank installed in the electric vehicle 11, by means of a piping with a valve, and by opening the valve. Maintaining the pressure of the hydrogen gas stored in the second storage unit 8 in the range from 10 to 70 MPa makes it possible to conduct the above described filling at high speed under the favor of pressure difference, namely, in such a short time not longer than 10 minutes.

The remaining amount of the hydrogen gas stored in the second storage unit 8 is detected by the remaining amount detecting sensor 14, and the detected signal is transmitted to the reform control unit 15. The reform control unit 15 feedback controls the operation of the reformer 5 according to the detected signal transmitted from the remaining amount detecting sensor 14 and on the basis of a prescribed program.

Consequently, the reform control unit 15 controls the reformer 5 in such away that the amount of the generated hydrogen gas is increased when the remaining amount of the hydrogen gas stored in the second storage unit is small, and decreases the amount of the generated hydrogen gas is decreased when the remaining amount of the above described hydrogen gas is large.

What is claimed is:

1. A hydrogen supply unit comprising a reforming means for generating hydrogen gas by reforming a source gas, a first storage means for storing and supplying the hydrogen gas obtained by said reforming means to a first fuel cell used as a stationary electric power supply, and a second storage means for storing the hydrogen gas obtained by said reforming means and supplies to a second fuel cell used as a mobile electric power supply, wherein:
said second storage device comprises a pressurization means for pressurizing the hydrogen gas to be stored.

2. The hydrogen supply unit according to claim 1, wherein both of the storage devices comprise a purifying means for purifying hydrogen gas between said reforming device and both storage means, and both storage means store the hydrogen gas purified by said purifying means.

3. The hydrogen supply unit according to claim 1, wherein said first storage means stores hydrogen gas by use of a hydrogen absorbing alloy.

4. The hydrogen supply unit according to claim 3, wherein said first storage means releases the hydrogen gas from said hydrogen absorbing alloy by use of waste heat of said reforming means or waste heat of said first fuel cell.

5. The hydrogen supply unit according to claim 1, wherein the hydrogen gas stored in said second storage means is pressurized by said pressurizing means to a pressure in a range from 10 to 70 MPa.

6. The hydrogen supply unit according to claim 1, wherein the unit comprises a remaining amount detecting means for hydrogen gas for detecting a remaining amount of the hydrogen gas stored in said second storage means, and a control means for feedback controlling the amount of the hydrogen gas generated by said reforming means on the basis of the remaining amount of the hydrogen gas detected by said remaining amount detecting means for hydrogen gas.
